(19) United States
(12) Patent Application Publication
(10) Pub. No.: US 2003/0181091 A1
(43) Pub. Date: Sep. 25, 2003

(54) Computer transporter in a drawer

(76) Inventor: Richard Zodnik, San Juan Capistrano, CA (US)

Correspondence Address: IRELL & MANELLA LLP, 840 NEWPORT CENTER DRIVE, SUITE 400, NEWPORT BEACH, CA, 92660, US

(21) Appl. No.: 10/104,581

(22) Filed: Mar. 21, 2002

(51) Int. Cl. H01R 13/64

(52) U.S. Cl. 439/374

(57) ABSTRACT

A desk with a transporter computer that can be plugged into a drawer of a desk. The transporter computer is plugged into a backplane that is located within the drawer and is coupled to a screen.

### BACKGROUND OF THE INVENTION

1. Field of the Invention

The present invention relates to a portable computer that can be plugged into a drawer of a desk.

2. Background Information

Most commercial offices are configured to allow a plurality of computers to be connected to one or more servers in a network. The network may include a local area network (LAN) and/or a wide area network (WAN). The computers are typically linked to the network through a data port that is physically connected to a number of routing wires. Each computer has an associated network address. Each data port has an associated physical address. The network will typically have a router(s) and hub that route information directed to the network addresses of the computers to the appropriate physical addresses of the data ports.

Some computers also have modem boards that are connected to voice ports of a telephone network. Each voice port has a unique phone number to allow routing of incoming information transmitted through the phone network. The telephone network will typically have switches to route phone calls to the appropriate voice ports.

The server of the network may have a software program that allows an operator to correlate the network address of the computer with the physical address of the data port. This correlation allows the network router and hub to route information to the appropriate computer. Likewise, the switch(es) of the telephone network may have a software program that allows an operator to correlate a phone number with a particular a physical cable number associated with the voice port.

Commercial entities will periodically move employees to different office locations. This typically requires moving the employee's computer. Each time a computer is moved to a different location an operator must re-configure the server and/or phone switches to correlate the computer with the new data and voice port locations. Re-configuring the network is time consuming and adds to the cost of moving the employees. Additionally, the employee is unable to move the computer without seeking the assistance of an operator to re-configure the network. This limits the mobility of the employee and their computer.

Most commercially available computers are constructed as a “tower” that is placed under a desk. The tower is coupled to a screen, printer, etc. with a plurality of cables and wires. The tower can occupy valuable leg room under a desk. Additionally, both the tower and wires can degrade the asthetics of an office. It would be desirable to provide a computer assembly that is compact, portable and would be hidden from view.

### BRIEF SUMMARY OF THE INVENTION

A desk with a transporter computer that can be plugged into a drawer of a desk. The transporter computer is plugged into a backplane that is located within the drawer and is coupled to a screen.

### BRIEF DESCRIPTION OF THE DRAWINGS

FIG. 1 is an illustration showing an embodiment of a computer and a backplane;

FIG. 2 is a schematic of a system that includes the computer and the backplane;

FIG. 3 is a diagram showing a relational database stored by a server of the system;

FIG. 4 is a flowchart showing an operation of the system;

FIG. 5 is a diagram showing an alternate embodiment wherein the system includes a server that is coupled to a phone switch by a network connection;

FIG. 6 is an illustration showing an alternate embodiment of a backplane that can be coupled to a computer;

FIG. 7 is a perspective view of a desk assembly;

FIG. 8 is a perspective view showing a transporter computer within a drawer of the desk;

FIG. 9 is a perspective view showing the computer pulled out of the drawer.

### DETAILED DESCRIPTION OF THE PREFERRED EMBODIMENT

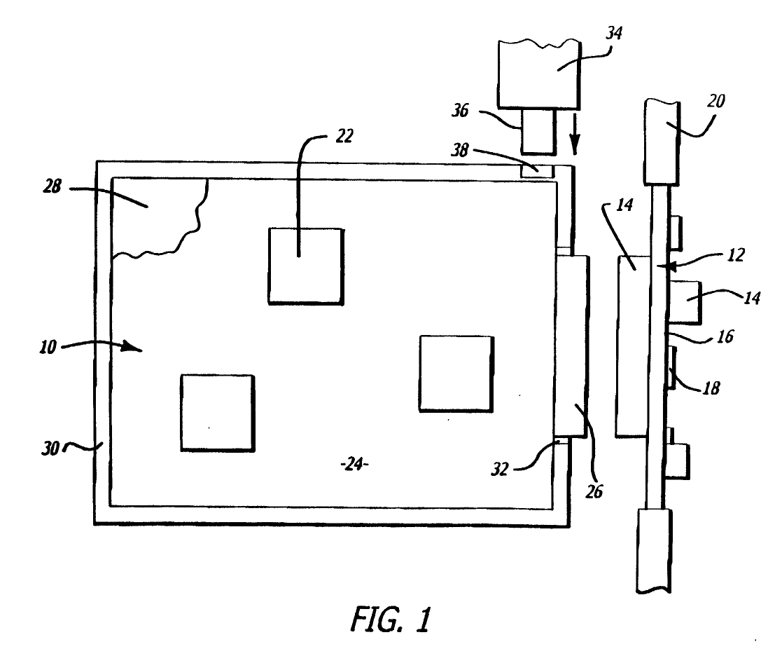

Referring to the drawings more particularly by reference numbers, FIG. 1 shows a computer 10 and a backplane 12. The backplane 12 may include a plurality of electrical connectors 14 mounted to a printed circuit board 16. Each electrical connector 14 may have a keying feature to insure that only the proper corresponding device can be mated with the connector 14. The printed circuit board 16 may support a plurality of integrated circuits 18 that are coupled to the connectors 14. The backplane 12 may be mounted to a structure 20 such as a wall.

The computer 10 may include a plurality of integrated circuits 22 mounted to a printed circuit board 24. The integrated circuits 22 may be connected to an electrical connector 26 that is attached to the board 24. The connector 26 may mate with one of the connectors 14 of the backplane 12. The printed circuit board 24 may also be connected to a hard disk drive 28. The hard disk drive 28 is coupled to the integrated circuits 22. The printed circuit board 24, integrated circuits 22 and hard disk drive 28 may all be enclosed by an outer housing 30. The outer housing 30 may have an opening 32 to allow the connectors 26 and 14 to mate.

The system 14 may include a mechanical lock 34 that is mounted to the structure 20. The lock 34 can be actuated to secure the computer 10 to the backplane 12. By way of example, the lock 34 may be a solenoid actuated plunger 36 that moves into a corresponding slot 38 the housing 30. The plunger 36 can be moved out of the slot 38 to allow the computer 10 to be pulled out of the backplane 12.

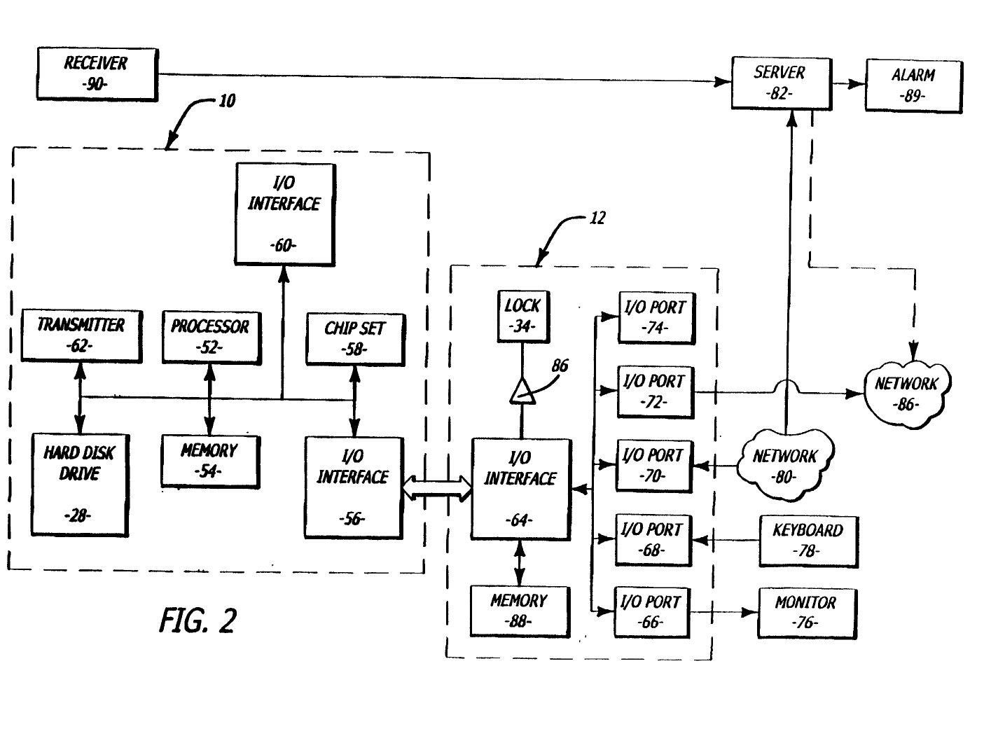

FIG. 2 shows a schematic of a system 50 that includes the computer 10 and the backplane 12. The computer 10 may include a microprocessor 52 that is coupled to one or more memory devices 54, an input/output (I/O) interface 56 and the hard disk drive 28. The memory devices 54 may include volatile and/or non-volatile memory such as dynamic random access memory (DRAM), static random access memory (SRAM) and read only memory (ROM).

The I/O interface 56 is connected to the connector 26. The microprocessor 52 may be connected to a graphics controller that is integrated with other functions such as bus management in an integrated circuit commonly referred to as a chip set 58. The microprocessor 52 may also be connected to a secondary I/O interface 60. The secondary I/O interface 60 can be coupled to an external device such as additional memory (not shown).

The computer 10 may also have a transmitter 62 that can wirelessly transmit signals. By way of example, the transmitter 62 can transmit signals at radio frequency (RF), The transmitter 62 may be coupled to a non-volatile memory device that contains an RF id. If the computer 10 is not properly shut down and detached from the backplane 12, the transmitter 62 may then automatically transmit the RF id on a continuous or periodic basis. For example, the computer 10 may require a password or biometric entry to properly shut down and remove the computer 10. If the password/biometric is not properly entered and the operator pulls the computer 10 out of the backplane 12 the processor 52 may cause the transmitter 62 to emit the RF id. The computer 10 would have a battery (not shown) to provide power to the transmitter 62.

The backplane 12 may have an I/O interface 64 that is connected to I/O ports 66, 68, 70, 72 and 74. Each I/O port 66, 68, 70, 72 and 74 is connected to a corresponding electrical connector. The I/O interface 64 is also connected to a connector that can be mated to the computer 10.

The I/O ports 66, 68, 70, 72 and 74 can be connected to external devices that communicate with the backplane 12 using different signals and different protocols. The interface 64 may contain the protocols required to transmit information through the ports 66, 68, 70, 72 and 74. The ports 66, 68, 70, 72 and 74 may have circuits to drive the signals to interface with the physical layer of the external device.

By way of example, I/O port 66, may be connected to a monitor 76. The I/O interface 64 and port 66 can be configured to transmit signals from the computer 10 in accordance with signal levels, protocols required to drive the monitor 76. The I/O interface 64 may include a hot plug firmware routine that determines the protocol, signals required to drive the monitor 76 through a series of handshake signals transmitted between the devices 64 and 76.

I/O port 68 may be connected to a keyboard 78. The interface 64 and port 68 may be configured to provide protocols and signal levels which allow information to be transmitted from the keyboard 78 to the computer 10.

I/O port 70 may be connected to a network 80. The network 80 may be connected to a server 82. By way of example, the I/O port 70 may include integrated circuits that transmit signals in accordance with an Ethernet standard.

Information may be transmitted through the network 80 in accordance with a Transmission Control Protocol/Internet Protocol (TCP/IP). I/O port 72 may be connected to a telephone network 86. The telephone network 86 may be a plain old telephone system (POTS), a public telephone network (PTN), Integrated Service Data Network (ISDN), Digital Subscriber Line (DSL) or another other phone service. The interface 64 and port 72 may transmit information in accordance with the signal levels, frequencies, protocols, etc. of the telephone network.

I/O port 74 may be an open port for additional devices. For example, port 74 may support USB protocol. The backplane 12 may have additional ports that support other post, present and future protocols and physical layer specifications. The I/O interface 64 may also be connected to the lock 34 by lock driver 86.

The backplane 12 may have a memory device 88 that is connected to the I/O interface 64. The memory device 88 may be non-volatile memory such as an EEPROM. The memory device 88 may include a backplane identification. The backplane identification is unique to the backplane 12.

By way of example, there are typically a plurality of backplanes 12 connected to the networks 80 and 86. Each backplane 12 will have a different backplane identification. The backplane identification may be a series of alphanumeric characters. The backplane identification may also be encrypted.

The computer 10 may store a unique client identification. The client identification may include personal information of the computer end user. The personal information may include a network address and telephone number for the computer. The client identification may be encrypted or otherwise encoded. The client identification may be stored in at least one hidden sector of the hard disk drive, to prevent unauthorized access to the client ID.

The server 82 may also be connected to the telephone network 86, an alarm 89 and a receiver 90. The receiver 90 can be adapted to receive the signal emitted by the transmitter 62 of the computer 10. The alarm 89 may include an audio and/or visual indicator such as a speaker and LCD display, respectively.

The network 80 may include routers and hubs (not shown) that route information to the computer 10 in accordance with a network address. By way of example, the network address may be an Internet Protocol (IP) address. Likewise, the telephone network 84 may switch information to the computer 10 in accordance with a telephone number.

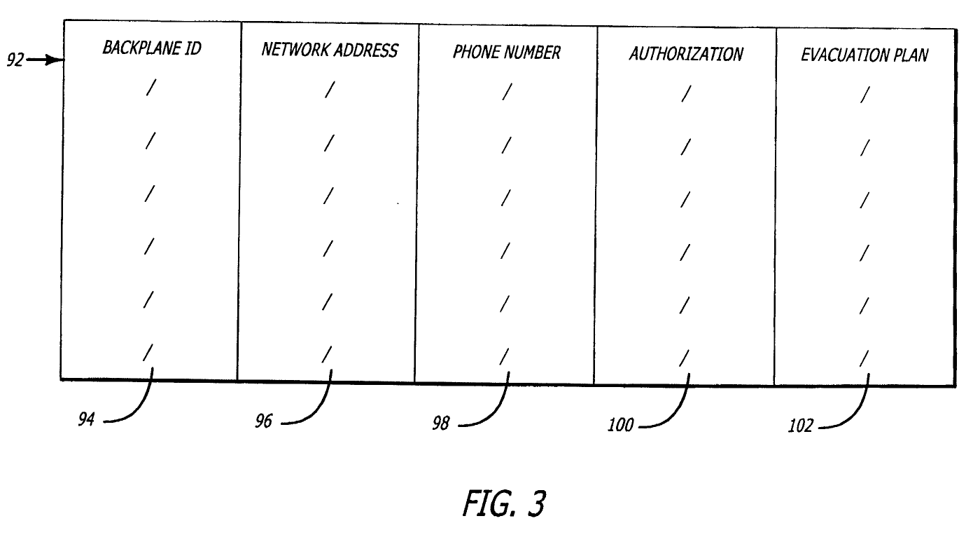

As shown in FIG. 3, the server 82 may include a relational database 92. The database 92 may have a backplane identification field 94, a network address field 96, a phone number field 98, an authorization field 100 and an evacuation plan field 102. The database 92 correlates each backplane identification and corresponding physical cable numbers of both the network connection and phone connection of the corresponding backplane, with a network address, phone number and evacuation plan.

The server 82 may operate in accordance with a software routine that accepts a command from the computer 10 and reconfigures the networks 80 and 84 in accordance with the command. For example, the command may include the client identification and an instruction to re-configure the networks 80 and 84. The server 82 will then correlate the backplane identification and evacuation plan with the network address and phone number associated with the client identification. The server may include a look-up table that associates the client identification with a network address and phone number. The server 82 can then vary the network relational database to correlate the address and phone number of the client ID with the backplane that is mated with the computer. Once the networks 82 and 84 are re-configured all information associated with the address and phone number of the computer 10 will be routed to the appropriate backplane. The computer ID automatically re-configures the network(s) by transmitting a command. There is no requirement to manually re-configure the system.

The server 82 may also have a software routine that compares the client identification with an authorized client identification and activates the alarm if the identifications do not match. The server 82 may also send a command to the backplane 12 to drive the lock into a locked position so that the end user cannot unplug the computer 10 from the backplane. The server may also inhibit operation of the computer. For example, the server may send a command(s) to turn off the computer 10, or prevent communication through the backplane 12.

The transmitter 62 may transmit the RF id if the computer 10 is improperly detached from the backplane 12. The RF id signal is received by the receiver 90. The server 82 may have a software routine that drives the alarm 88 and records the alarm event when the receiver 90 senses the RF id.

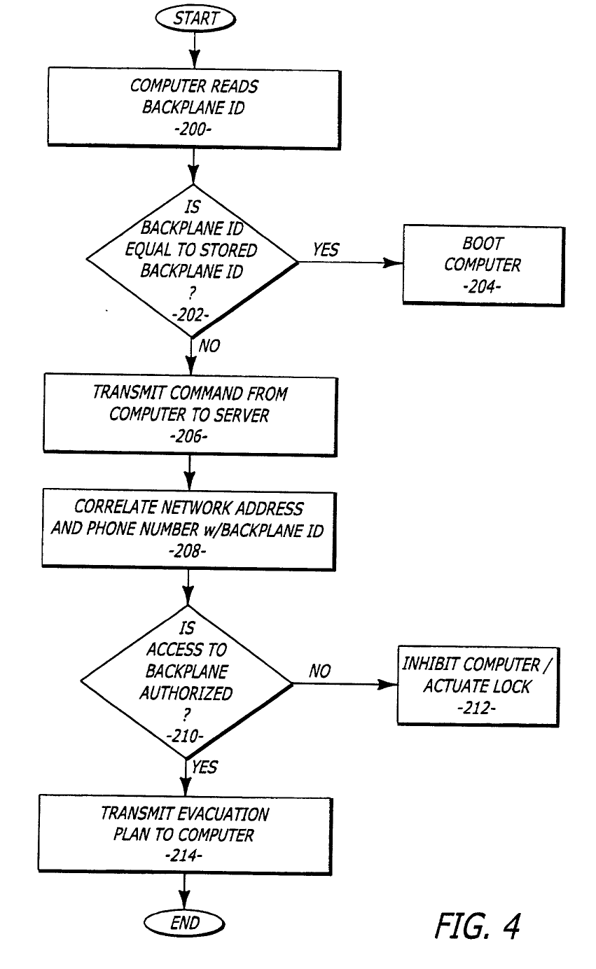

The microprocessor 52 may operate in accordance with a software routine. The software routine may be performed in accordance with instructions and data stored within memory 54 and/or the hard disk drive 28. FIG. 4 describes an operation of the system by software routines performed by the computer 10 and the server 82.

The end user initially plugs the computer 10 into the backplane 12. The computer 10 then reads the backplane identification from the memory device 88 in process block 200. The backplane ID can be read during an initialization routine of the computer 40, wherein the processor 52 request data from the appropriate address(es) of the backplane memory 76. In decision block 202 the computer 10 compares the backplane identification transmitted from the backplane with a stored backplane identification. The stored backplane identification is the backplane ID for the backplane that was last coupled to the computer 10. If the identifications match, a boot up routine is run so that the computer 10 can be operated in process block 204. Matching IDs signifies that the computer 10 has not been moved to a different backplane.

If the identifications do not match, the computer transmits a command to the server in block 206. The command may include the client identification. The client ID may be retrieved from the hidden sector(s) of the hard disk drive 28.

The command may be routed to the server in accordance with a server network address entered into the computer through a configuration program. Alternatively, the server may download the network address when the computer ID is plugged into the backplane 12. The backplane 12 may send a signal to prompt a download of the server network address when the connectors 14 and 26 are mated. The server then correlates the client identification information such as network address and phone number with the backplane identification in block 208. All information addressed to the network address and/or phone number will then be routed to the corresponding backplane associated with the client identification.

The server may compare the client identification with an authorized client identification in decision block 210. If authorization is not granted the server may transmit a command(s) to the backplane to inhibit operation of the computer and/or engage the lock in process block 212. If authorization is granted the server may then transmit a evacuation plan 214 to the computer 10. The evacuation plan may include diagrams, etc. that show the end user an evacuation route from the facility. The evacuation plan is unique to the backplane, such that the evacuation route is specifically directed to the physical location of the backplane. The computer 10 can be booted subsequent to the transmission of the command in step 206.

The present invention thus provides a system and method to automatically re-configure a network when a computer is plugged into a backplane.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

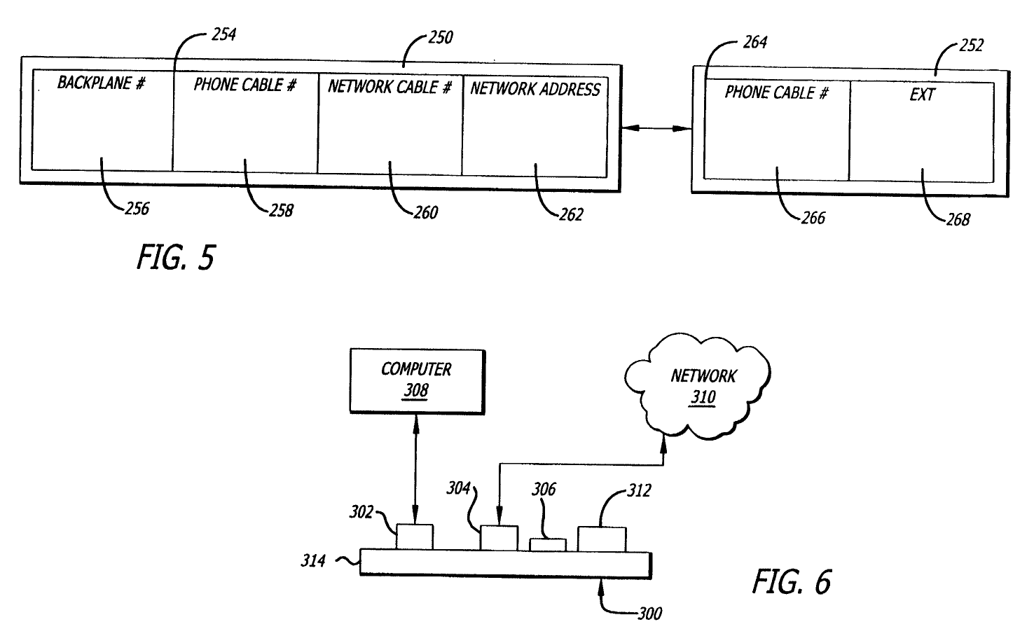

For example FIG. 5 shows an alternate embodiment of a system with a server 250 connected to a phone switch 252. The server 250 includes a relational database 254 that has a backplane identification field 256 that is correlated with a phone cable number field 258, a network cable number field 260 and a network address field 262. The cable numbers correspond to the physical cables that are attached to the backplane with the corresponding backplane identification.

The phone switch 252 may have a relational database 264 that has a phone cable number field 266 and a phone number field 268. When the computer 10 is plugged into a different backplane both relational databases 254 and 264 are updated to correlate the network address and phone number of the computer with the physical cables attached to the backplane. This embodiment is similar to the embodiment shown in FIG. 3, except that the correlation between the phone number and cable number is provided in the phone switch 252. Conventional phone switches already have such correlations. This embodiment thus provides a system that can be readily integrated into existing phone systems. The servers 250 and 252 can be linked by a network line. By way of example, the network line may operate in accordance with an Ethernet protocol. Connecting servers 250 and 252 over a network line may allow voice over IP service for the system. Incoming phone calls can be routed to the backplane through the servers 250 and 252.

FIG. 6 shows another embodiment of a backplane 300 that has a pair of network connectors 302 and 304, and one or more integrated circuits 306. Connector 302 can be coupled to a computer 308. Connector 304 can be coupled to a network 310. The integrated circuits 306 may include a backplane identification, hardware and firmware that allow the computer 308 to be connected to the network 310 in accordance with the teachings of the embodiment shown in FIGS. 1-4. The backplane 300 may be packaged as a consumer product that can be purchased and connected to an existing computer 308. The product may also include software that can be loaded into the computer 308 to operate the routine shown and discussed in the embodiments of FIGS. 1-4. The backplane 300 may have an additional power connector 312 to provide power for the integrated circuits 306. The connectors 302 can be plugged into the LAN connections of the computer 308 and network 310. The connectors 302, 304, 312 and integrated circuits 306 may be mounted to a single printed circuit board 314.

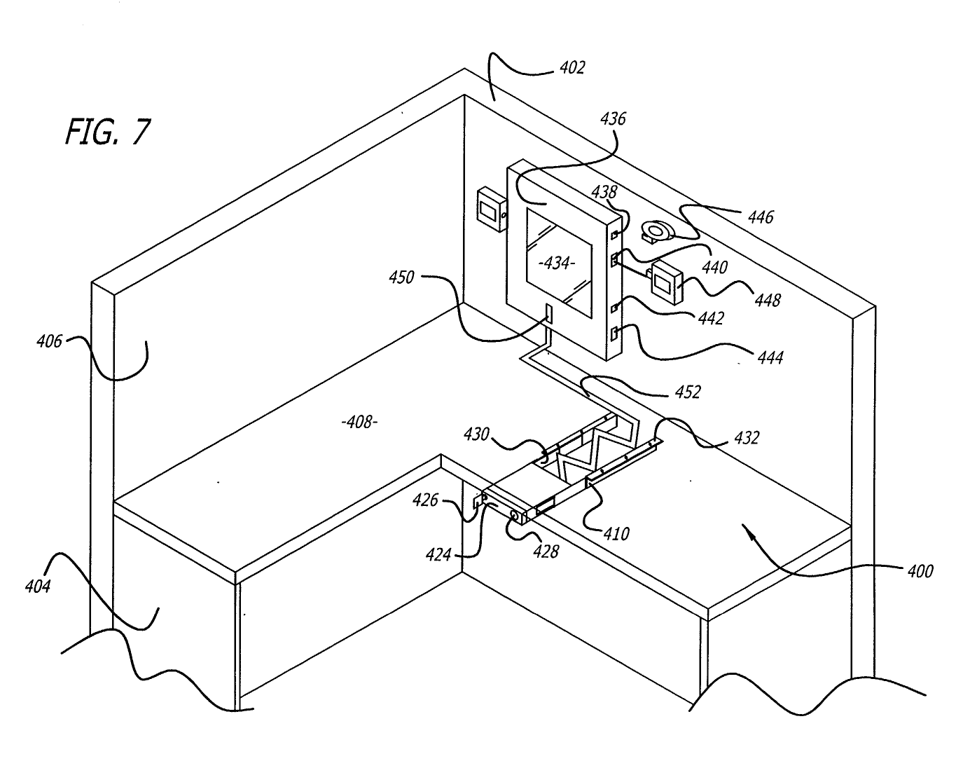

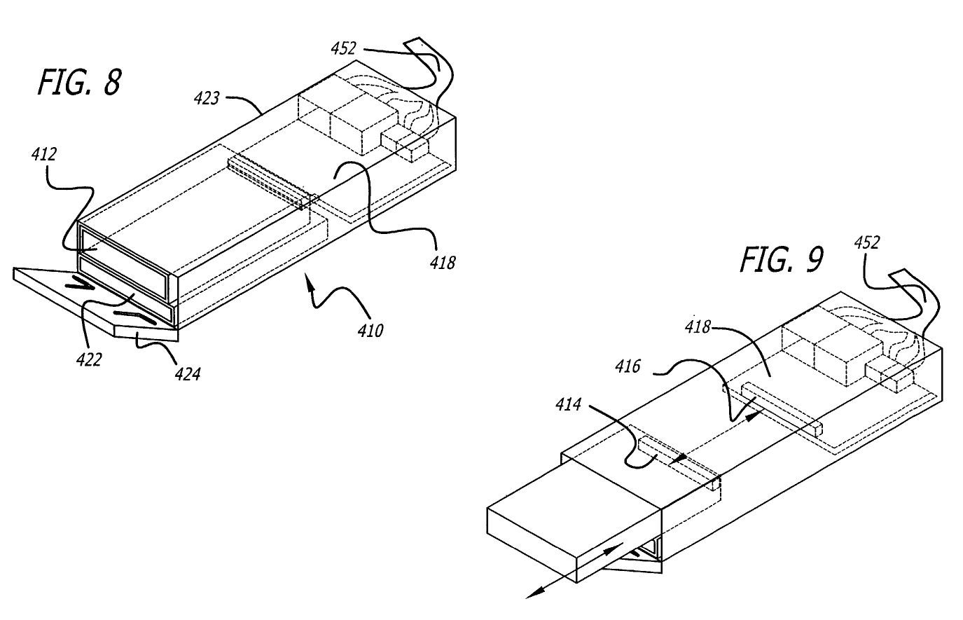

FIGS. 7, 8 and 9 show an embodiment of a desk assembly 400. The desk 400 includes a frame 402 that has legs 404, walls 406 and a table top 408. The frame 402 may be constructed from a variety of different materials including wood, metal and/or plastic.

The assembly 400 includes a drawer 410 that can house a transporter computer 412. The computer 412 may be the same or similar to the computer shown in FIGS. 1 and 2. The drawer 410 may be attached to an underside of the table top 408. Housing the computer 412 under the table top 408 creates space under the desk that is normally occupied by a computer “tower”. The drawer 410 is preferably inset under the table top 408 so that the computer 412 is not seen when installed into the desk 400. This improves the appearance of the office environment.

The computer 412 may have an electrical connector 414 that plugs into a corresponding connector 416 of a backplane 418 located in an inner cavity 420 of the drawer 410. The backplane 418 may be the same or similar to the backplane shown in FIGS. 1 and 2. The drawer 410 may also contain a disk player 422 such as a compact disk (CD) player, or a digital video disk (DVD) player. The disk player 422 may be coupled to the computer 412 through the backplane 418. The computer 412, disk player 422 and backplane 418 are located within a housing 423 of the drawer 410.

The drawer 410 may include a front cover 424 that can be moved between an open position to allow the transporter 412 to be removed from the desk 400, to a closed position to enclose the computer 412. The front cover 424 may include a lock 426 that allows the user to secure the computer 412 within the desk 400. The front cover 424 may also have an ON/OFF switch 428 that allows the user to turn the computer 412 on and off.

The drawer 410 may include a roller assembly 430 that allows the drawing housing 423 to be pulled from under the desk top 408. The roller assembly 430 may include mounting brackets 432 that are attached to the bottom surface of the table top 408.

The desk 400 may include a screen 434 that is attached to a panel 436 that is mounted to the desk frame 402. The panel 436 may include a plurality of connectors 438, 440, 442 and 444. Connectors 438 and 440 can be coupled to a video camera 446 and speakers 448, respectively. Connectors 442 and 444 may be a microphone input and a RJ11 telephone jack, respectfully. The panel 436 may also include a wireless receiver 450.

The computer 412 and back plane 418 may be coupled to the screen 434 and connectors 438, 440, 442 and 444 by a cable assembly 452. The cable assembly 452 extends from the drawer 410 and is plugged into the panel 436. The cable assembly 452 may have a length that allows the drawer 410 to be pulled from under the table top 408. The cable assembly 452 is routed under the table top 408. Routing the cable assembly 452 under the table top 408 improves the asthetics of the desk 400. Although a panel 436 with a screen 434 is shown and described, it is to be understood that the computer 412 could be connected to a conventional computer monitor that rest on the top surface of the table top 408.

What is claimed is:

1. A desk assembly, comprising:
a desk frame;
a drawer attached to said desk frame;
a backplane located within said drawer; and,
a transporter computer that can be plugged into said backplane within said drawer.

2. The assembly of claim 1, further comprising a screen that is coupled to said backplane and mounted to said desk frame.

3. The assembly of claim 1, wherein said drawer includes a cover and a lock.

4. The assembly of claim 1, wherein said drawer includes an on/off button.

5. The assembly of claim 1, wherein said transporter computer includes a processor, a memory device and a hard disk drive.

6. The assembly of claim 2, wherein said screen is attached to a panel that is mounted to said desk frame, said panel having a plurality of electrical connectors.

7. A desk assembly that can be coupled to a screen, comprising:
a desk frame;
a drawer attached to said desk frame;
a screen attached to said desk frame;
a transporter computer that can be stored within said drawer; and,
means for coupling said transporter computer to said screen.

8. The assembly of claim 7, wherein said means includes a backplane.

9. The assembly of claim 7, wherein said drawer includes a cover and a lock.

10. The assembly of claim 7, wherein said drawer includes an on/off button.

11. The assembly of claim 7, wherein said transporter computer includes a processor, a memory device and a hard disk drive.

12. The assembly of claim 7, wherein said screen is attached to a panel that is mounted to said desk frame, said panel having a plurality of electrical connectors.

13. A method for transporting a computer, comprising:
opening a drawer of a desk; and,
plugging a transporter computer into a backplane located within the drawer.

14. The method of claim 13, further comprising locking the drawer.
